(19) United States
(12) Patent Application Publication
(10) Pub. No.: US 2026/0141418 A1
(43) Pub. Date: May 21, 2026

(54) AUTOMATIC GENERATION CUSTOMER PROFILES BASED ON PRIOR TRANSACTIONS

(71) Applicant: NCR Voyix Corporation, Atlanta, GA (US)

(72) Inventors: Jacob Regis Cronauer, Marietta, GA (US); Michael Jiang Tang, Alpharetta, GA (US); Yung-Hang Chang, Marietta, GA (US); Kun Zhu, Smyrna, GA (US); Michael Chand, Atlanta, GA (US)

(21) Appl. No.: 18/951,017

(22) Filed: Nov. 18, 2024

(51) Int. Cl. G06Q 30/0207; G06Q 30/0251

(52) U.S. Cl. CPC G06Q 30/0224; G06Q 30/0255; G06Q 30/0259

(57) ABSTRACT

System and techniques may be used for. An example technique may include retrieving collected transaction data saved from prior transactions at a retail location. The technique may include creating a customer profile of a customer of the retail location based on customer specific transactions from the collected transaction data for the customer, generating, using a trained large language model, a personalized promotion for the customer based on the customer profile, and outputting an indication of the personalized promotion on a user interface corresponding to the retail location.

### BACKGROUND

Retail locations process customer transactions through point-of-sale devices that record payment details, purchased items, and other transaction data. Merchants frequently offer promotional incentives, which may include manufacturer coupons, store-specific discounts, or digital offers that can be redeemed during checkout. These promotional offers are validated at the point of sale, such as with transaction details.

### SUMMARY

In various embodiments, methods and systems are disclosed for automatically generating a personalized promotion for a customer based on a customer profile, including through use of a trained large language model.

According to an embodiment, a method may include retrieving historical transaction data relating to prior transactions at a retail location, creating a customer profile of a customer of the retail location based on transactions specific to the customer from the transaction data, generating, using a trained large language model, a personalized promotion for the customer based on the customer profile, and outputting an indication of the personalized promotion on a user interface corresponding to the retail location.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a system for generating a personalized promotion for a customer in accordance with some examples.

FIG. 2 illustrates a user interface to manage personalized promotions for customers in accordance with some examples.

FIG. 3 illustrates a machine learning engine for training and execution related to generating a personalized promotion for a customer in accordance with some examples.

FIG. 4 illustrates generally a flowchart showing a technique for generating a personalized promotion for a customer in accordance with some examples.

FIG. 5 illustrates generally an example of a block diagram of a machine upon which any one or more of the techniques discussed herein may perform in accordance with some embodiments.

### DETAILED DESCRIPTION

Systems, methods, techniques, and methodologies described herein may be used to automatically generate a personalized promotion for a customer based on a customer profile, including through use of a trained large language model. The customer profile may be generated by segmenting or stratifying a customer based on a transaction history of the customer. The transaction history may be tied to a loyalty account, such as with a brand or a store.

Retailers often find it challenging to effectively use the large quantities of transaction data they collect. Generic marketing campaigns typically yield low returns, while crafting personalized promotions for individual customers remains resource intensive and is often ineffective due to human error. Existing customer relationship management systems may lack comprehensive insights and thus not fully understand customer behavior and preferences, resulting in missed opportunities for boosting customer loyalty and driving sales. Data silos further hinder the achievement of a holistic view of the customer, exacerbating these challenges.

The systems and techniques described herein use existing retail transaction data, for example transaction data captured by a transaction system, to develop a comprehensive and robust customer relationship management asset. A multi-dimensional customer profile may be generated for a customer using segmentation or clustering algorithms based on customer type (e.g., an energy drink and an extra-large coffee may be clustered into a “Daily Brew Crew Category”). In some example embodiments, natural language processing may be used to link transactions together.

These analytical profiles may be used to provide a highly personalized promotion for a customer that effectively drives increased store visits or consumer spending. For example, a promotion may initially target a customer by showcasing a preferred product of the customer. Using the systems and techniques described herein, the promotion may be seamlessly extended to thousands of other customers who exhibit comparable purchasing behaviors.

This level of personalization may be based on a transaction system data infrastructure, to provide retailers of any size or segment with access to a scalable and efficient promotional tool. By leveraging this technology, retailers may unlock deeper insights into customer preferences and spending patterns. The systems and techniques described herein enable delivery of promotions that are not only relevant but also timely, which increases engagement and loyalty across the customer base.

A customer profile may be based on or combined with an existing or new loyalty program. A loyalty program may be specific to a brand, a company, a retail location, a restaurant, a retailer, or the like. A loyalty program may use a customer email, identifier, phone number, app, etc. to group transactions for use in generating a customer profile. The loyalty program may facilitate (e.g., via an opt in) a customer receiving a promotion from a store operator. The store operator may access the customer profile, information about the customer or the loyalty program via a web portal (e.g., accessed via a user interface, such as via a website). The web portal may include an analytics dashboard or a promotional launcher portal that may be used to trigger sending a promotion to one or more customers. The analytics dashboard may include data related to trends in consumer group behavior. The promotional launcher portal may provide the store operator with the capability to monitor or set guardrails on types of promotions that are sent out.

The systems and techniques described herein provide for generating a multi-dimensional profile using advanced machine learning techniques. The profiling is used to generate rich, granular customer profiles that extend beyond basic demographics and purchase history. A customer profile may be generated by analyzing shopping habits, preferred product categories, visit frequencies, or other nuanced factors (e.g., time of day of purchase, holiday related spending, etc.).

After a customer profile is generated, a machine learning model may be used to generate an automated promotion. A personalized promotion may be automatically generated based on an individual profile and optionally an identified trend, minimizing manual effort while ensuring relevance across diverse retail settings (e.g., a store selling goods or services, a restaurant, a retailer, etc.).

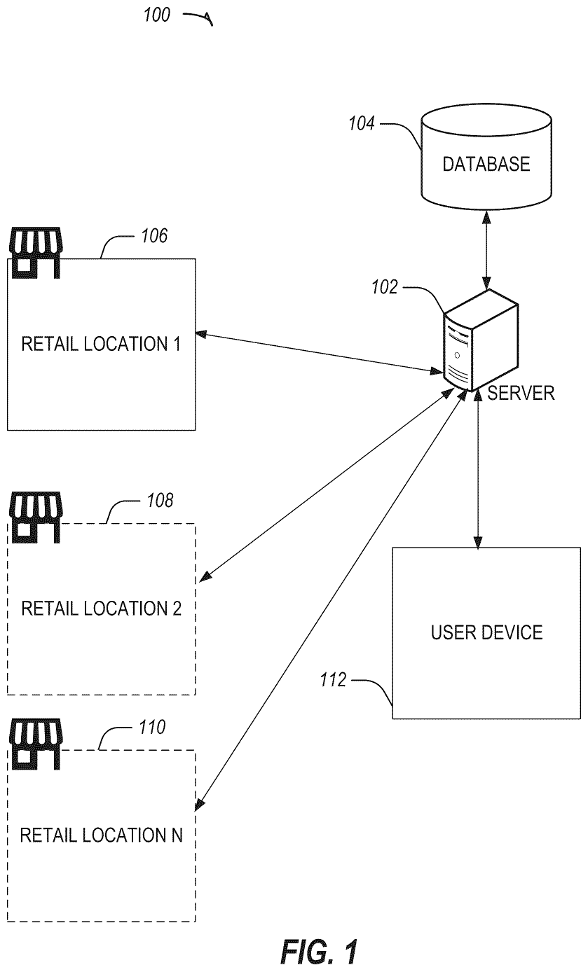

FIG. 1 illustrates a system 100 for generating a personalized promotion for a customer in accordance with some examples. The system 100 includes a server 102, which may be in communication with or include a database 104. The server 102 may receive data from a first retail location 106, and optionally other retail locations (e.g., a second retail location 108, an nth retail location 110, etc.). The server 102 may communicate with a user device 112 (e.g., to send analytic data, to send an indication of a promotion generated using machine learning, to receive instructions to send out one or more promotions, etc.).

The server 102 may receive transaction data from the first retail location 106 (e.g., from one or more point of sale devices). In some examples, the transaction data is sent directly from a point-of-sale device and does not require a store operator of the first retail location 106 to be involved in the data storage and sending processes. When the server 102 receives the transaction data, the transaction data may be stored in the database 104, such as in accordance with a customer loyalty account.

The user device 112 may display a user interface, such as a website, including an analytics portal or a promotion portal. Either or both portals may be populated with data received from the server 102 (e.g., retrieved from the database 104). The user device 112 may send a request for a promotion for a customer or a set of customers to the server 102. After the server 102 receives the request, the server 102 may run a query (e.g., as included in the request) for a promotion for the customer or the set of customers. The query may include using a customer profile for the customer or a type of the customer or a type of the set of customers. The customer profile may be generated from the transaction data stored in the database 104. The customer profile may be generated in an on-going basis (e.g., periodically, according to a schedule, etc.) or on-demand. For example, the customer profile may be generated and stored in the database 104. The server 102 may use the customer profile and a query as input to a trained machine learning model (e.g., a large language model) to generate a promotion. The promotion may be selected by the model from a set of preapproved promotions (e.g., as sent by the user device 112 or saved in the database 104 or the server 102). The promotion, after being generated by the model, may be sent to the user device 112 for display.

In some examples, customers are segmented based on spending behavior, shopping habits (e.g., frequency, preferred categories, weekday vs. weekend visits), or other pertinent factors. For example, a large language model may be used, such as one that is reduced in scope and prompt (e.g., similar to a small language model that has a refined purpose.) This reduction in scope allows the cloud computing power to be reduced and processing sped up. Categories of customer (e.g., customer type or profile type) may be identified or created over time. For example, a large language model may be queried to determine a trend over time.

In an example, the first retail location 106 is a highway fuel refilling station. In this example, a promotion may include a fuel and food combo reward to encourage spending by offering bonus reward points for combined fuel and large drink purchases during specific times. Another example promotion may include a rest stop refreshment deals to attract customers with discounts on snacks and beverages, adaptable to various retail environments (e.g., a store selling goods or services, a restaurant, a retailer, etc.). Other promotions may use a tiered spending incentive to motivate continued patronage with escalating discounts or coupons based on spending thresholds.

In the highway fuel refilling station example, thresholds for strata may include groups based on total spending by a customer (e.g., within a particular time frame), such as categories of: Very High: $3500+, High: $1200-3500, Medium: $30-1200, and Low: $0-30. Segmentation within the strata may include segmenting customers by their spending habits (e.g., shopping frequency, preferred product category, weekday or weekend, or the like). Customers may have a type in their profiles, such as, professional drivers, lunch shoppers, pit stop shoppers, daily brew crew, other, or the like. For example, a professional driver may have a primary spend on fuel and personal care. The professional driver may be a truck driver with a highest total spend among types of customers. The professional driver may visit throughout the week. A pit stop shopper may have a primary spend on snacks and beverages, low spend on commodity items, and visit on the weekends. A hot lunch shopper may have a primary spend on prepared food, and visit weekdays.

Considering the professional driver type in the example above, a promotion may be generated for a fuel and food combination including a reward points multiplier. The promotion may be based on analysis that shows that many truck drivers primarily refuel during early mornings but spend less on food purchases during these visits. The promotion may include a morning refuel breakfast deal where drivers who purchase 100 gallons of fuel before 9 AM receive a 50% discount on any breakfast combination. This may encourage truckers to pair their early fuel stops with a breakfast purchase, increasing morning food sales.

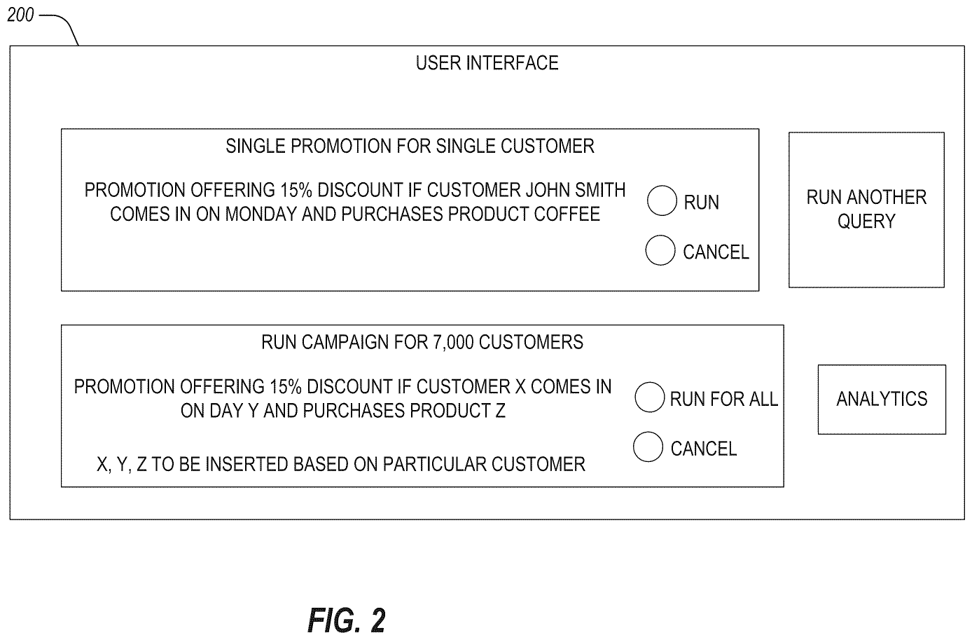

FIG. 2 illustrates a user interface 200 to manage personalized promotions for customers in accordance with some examples. The user interface 200 shows promotion generation and sending components. The user interface 200 includes an option to return to an analytics dashboard.

The user interface 200 includes a component to send a single promotion for a single customer. This promotion may be one that was previously generated using a large language model based on a customer profile for the customer. The promotion is automatically populated into the user interface component, and a store operator may select whether to run the promotion for the customer or cancel the promotion. The store operator may select to run another query, such as for the customer (e.g., an alternative promotion) or for another customer or set of customers.

The user interface 200 includes a component to run a campaign for a set of customers (in the example of FIGS. 2, 7,000 customers). The campaign may be selected (e.g., by a large language model) to run for a set of customers that correspond to a customer type. The customer type may be a segment or strata based on customer profiles of the customers in the set of customers. In the example shown in FIG. 2, a promotion was generated by a large language model to run for 7,000 customers based on a shared customer type to the single customer discussed above. The promotion is shown in the user interface 200 as one “offering 15% discount if customer X comes in on DAY Y and purchases product Z.” The placeholders X, Y, and Z are not sent to any of the set of customers, but instead are replaced or omitted for each customer of the set of customers based on individual customer profiles. For example, if “run for all” is selected, 7,000 messages (e.g., texts, emails, etc.) may be generated, with each one having a particular name, day, and product inserted. For example, because the single customer discussed above is part of the set of customers, the promotion for the single customer replaces X with “John Smith,” Y with “Monday,” and Z with “Coffee.” In other examples, the name or day may be omitted. When generating the promotion, the large language model may be restricted based on pre-approved promotions, which may be provided verbatim or may be based on logic. For example, logic-based promotion restriction may include limiting to relative values for percentages, such as, only provide 10% on food items and 15% at max on clothing items, or may include specific instructions, such as never provide gift card promotions, no promotions on cigarettes, or no promotions to a minor for alcohol, etc. Specific products may be excluded or specific products may be selected as the only ones available for a promotion (e.g., either opt in or opt out). A promotion may be selected based on a query to a large language model, such as “Please generate three promotions based on this customer's current buying habits” along with the customer profile, and “Please increase check size or total number/frequency of visits based on customer profile.” In some examples, the large language model may output justification for why a particular promotion was selected so that a store operator may use additional judgment for selecting whether to run a promotion. In some examples, the user interface 200 may include a selectable option to automate sending promotions. For example, promotions may be sent to the set of customers automatically, such as on a scheduled basis. In some examples, retail goods may be identified by a machine learning model leveraging transaction data. For example, when a customer purchased a product like dish soap, three months ago, the model may recognize the customer will need more soon and may provide a personalized promotion based on the date and item of the past consumption.

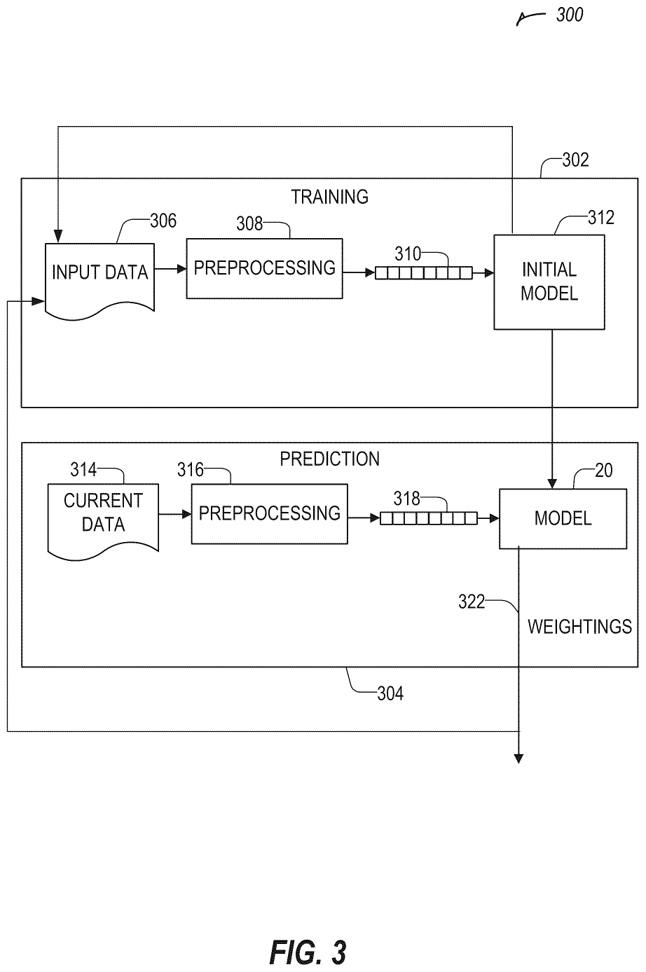

FIG. 3 illustrates a machine learning engine for training and execution related to generating a personalized promotion for a customer in accordance with some examples. The machine learning engine may be deployed to execute at a mobile device (e.g., a cell phone, a tablet, etc.) or a computer (e.g., a desktop, a laptop, etc.). FIG. 3 shows an example machine learning engine 300 according to some examples of the present disclosure.

Machine learning engine 300 uses a training engine 302 and a prediction engine 304. Training engine 302 uses input data 306, for example after undergoing preprocessing component 308, to determine one or more features 310. The one or more features 310 may be used to generate an initial model 312, which may be updated iteratively or with future labeled or unlabeled data (e.g., during reinforcement learning), for example to improve the performance of the prediction engine 304 or the initial model 312. An improved model may be redeployed for use.

The input data 306 may include previous transaction data, a customer profile, a strata (e.g., a purchase amount range or threshold), a segment (e.g., a type of customer), a customer location, a frequency of transactions, a time of day of a transaction, a day of week of a transaction, customer provided data (e.g., demographic data, a product preference, etc.), a set of potential promotions for a customer or customer type, or the like.

In the prediction engine 304, current data 314 (e.g., two items in a pair) may be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction engine 304 may be designed to operate in an online manner (e.g., in real-time, at a mobile device, on a wearable device, etc.). In some examples, the model 320 may be periodically updated via additional training (e.g., via updated input data 306 or based on labeled or unlabeled data output in the weightings 322) or based on identified future data, such as by using reinforcement learning to personalize a general model (e.g., the initial model 312) to a particular user.

Labels for the input data 306 may include a selected promotion or a set of available promotions for a customer based on the input data 306.

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

A language model may include a large language model (LLM), a natural language processing (NLP) model, or the like. Large Language Models (LLMs) are advanced artificial intelligence systems trained on vast amounts of text data to understand and generate human-like language. These models use deep learning techniques, particularly transformer architectures, to process and produce coherent and contextually relevant text across a wide range of topics and tasks. A NLP model is a model that analyzes and processes text data to translate, perform sentiment analysis, or generate text based on context.

Once trained, the model 320 may output a prediction, such as an indication of a personalized promotion, a justification for the personalized promotion based on the customer profile, etc. The output may be selected based on a command to increase check size for a future transaction of the customer or to increase a frequency of visits by the customer to the retail location, for example from a set of preapproved potential personalized promotions.

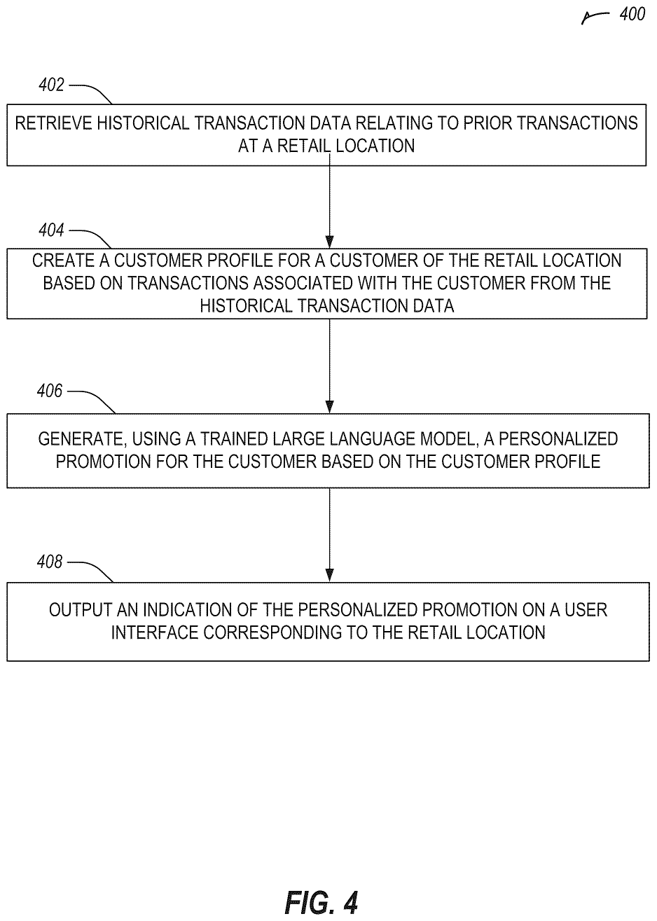

FIG. 4 illustrates generally a flowchart showing a technique 400 for generating a personalized promotion for a customer in accordance with some examples. The technique 400 includes an operation 402 to retrieve historical transaction data relating to prior transactions at a retail location (e.g., a store selling goods or services, a restaurant, a retailer, etc.). The collected transaction data may be stored according to loyalty accounts of customers (e.g., in a database). The technique 400 includes an operation 404 to create a customer profile of a customer of the retail location based on transactions associated with the customer (e.g., customer specific transactions) from the historical transaction data (e.g., of the customer).

The technique 400 includes an operation 406 to generate, using a trained large language model, a personalized promotion for the customer based on the customer profile. In an example, the personalized promotion is generated from a set of preapproved potential personalized promotions. The set of preapproved potential personalized promotions may be selected based on the customer profile. In an example, the personalized promotion is generated based on a command to increase check size for a future transaction of the customer or to increase a frequency of visits by the customer to the retail location. Operation 406 may include generating, using the trained large language model, a justification for the personalized promotion based on the customer profile.

The technique 400 includes an operation 408 to output an indication of the personalized promotion on a user interface corresponding to the retail location. Operation 408 may include outputting a promotion customized to the customer profile, receiving a selection to send the promotion customized to the customer profile, converting the promotion to two or more customer-specific promotions including the personalized promotion, and sending the two or more customer-Attorney specific promotions to respective customers having the customer profile including the customer.

The technique 400 may include stratifying a customer into a stratum based on values of customer transactions within the historical transaction data. The technique 400 may include segmenting the customer into a segment based on types of customer transactions within the historical transaction data. In an example the segment corresponds to a time of day of purchases, a day of week of purchases, or a frequency of transactions. In an example, the segment corresponds to a preferred product category of the customer extracted from the transactions (e.g., those associated with the customer). The technique 400 may include receiving, on the user interface, a selection to send the personalized promotion to the customer.

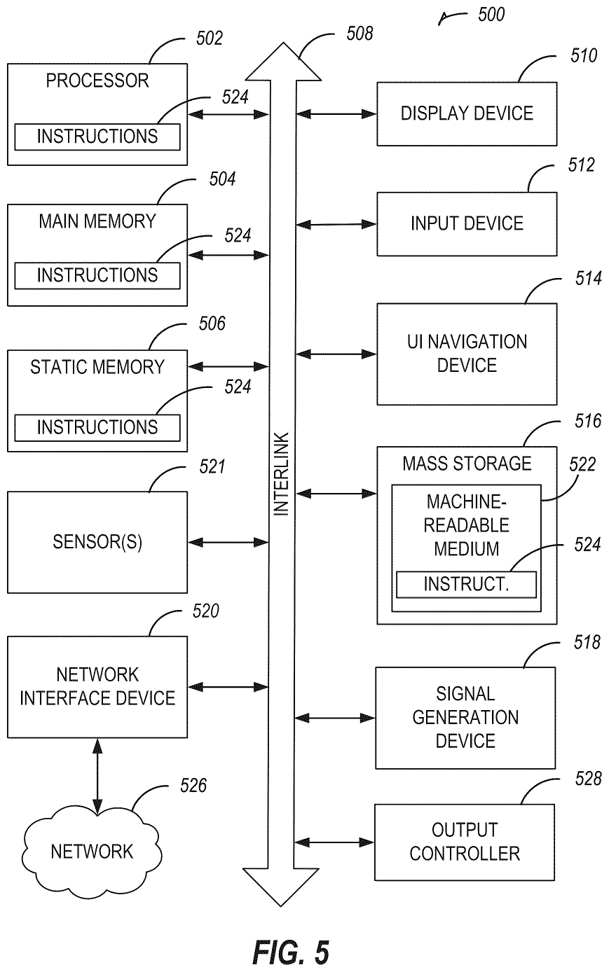

FIG. 5 illustrates generally an example of a block diagram of a machine 500 upon which any one or more of the techniques discussed herein may perform in accordance with some examples. In alternative examples, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

Each of these non-limiting examples may stand on its own, or may be combined in various permutations or combinations with one or more of the other examples.

Example 1 is a method comprising: retrieving historical transaction data relating to prior transactions at a retail location; creating a customer profile for a customer of the retail location based on transactions associated with the customer from the historical transaction data; generating, using a trained large language model, a personalized promotion for the customer based on the customer profile; and outputting an indication of the personalized promotion on a user interface corresponding to the retail location.

In Example 2, the subject matter of Example 1 includes, stratifying a customer into a stratum based on values of customer transactions within the historical transaction data.

In Example 3, the subject matter of Examples 1-2 includes, segmenting the customer into a segment based on types of customer transactions within the historical transaction data.

In Example 4, the subject matter of Example 3 includes, wherein the segment corresponds to a time of day of purchases, a day of week of purchases, or a frequency of transactions.

In Example 5, the subject matter of Examples 3-4 includes, wherein the segment corresponds to a preferred product category of the customer extracted from the transactions associated with the customer.

In Example 6, the subject matter of Examples 1-5 includes, wherein the personalized promotion is generated for the customer by the trained large language model from a set of preapproved potential personalized promotions.

In Example 7, the subject matter of Example 6 includes, wherein the set of preapproved potential personalized promotions are selected based on the customer profile.

In Example 8, the subject matter of Examples 1-7 includes, receiving, on the user interface, a selection to send the personalized promotion to the customer.

In Example 9, the subject matter of Examples 1-8 includes, wherein outputting the indication includes outputting a promotion customized to the customer profile, receiving a selection to send the promotion customized to the customer profile, converting the promotion to two or more customer-specific promotions including the personalized promotion, and sending the two or more customer-specific promotions to respective customers having the customer profile including the customer.

In Example 10, the subject matter of Examples 1-9 includes, wherein the personalized promotion is generated based on a command to increase check size for a future transaction of the customer or to increase a frequency of visits by the customer to the retail location.

In Example 11, the subject matter of Examples 1-10 includes, wherein the historical transaction data is stored according to loyalty accounts of customers.

In Example 12, the subject matter of Examples 1 -11 includes, wherein generating the personalized promotion includes generating, using the trained large language model, a justification for the personalized promotion based on the customer profile.

Example 13 is at least one non-transitory machine-readable medium including instructions, which when executed by processing circuitry, causes the processing circuitry to perform operations comprising: retrieving historical transaction data relating to prior transactions at a retail location; creating a customer profile for a customer of the retail location based on transactions associated with the customer from the historical transaction data; generating, using a trained large language model, a personalized promotion for the customer based on the customer profile; and outputting an indication of the personalized promotion on a user interface corresponding to the retail location.

In Example 14, the subject matter of Example 13 includes, wherein the instructions further cause the processing circuitry to perform operations comprising stratifying a customer into a stratum based on values of customer transactions within the historical transaction data.

In Example 15, the subject matter of Examples 13-14 includes, wherein the instructions further cause the processing circuitry to perform operations comprising segmenting the customer into a segment based on types of customer transactions within the historical transaction data.

In Example 16, the subject matter of Example 15 includes, wherein the segment corresponds to a time of day of purchases, a day of week of purchases, or a frequency of transactions.

In Example 17, the subject matter of Examples 15-16 includes, wherein the segment corresponds to a preferred product category of the customer extracted from the transactions associated with the customer.

In Example 18, the subject matter of Examples 13-17 includes, wherein the personalized promotion is generated for the customer by the trained large language model from a set of preapproved potential personalized promotions.

In Example 19, the subject matter of Example 18 includes, wherein the set of preapproved potential personalized promotions are selected based on the customer profile.

In Example 20, the subject matter of Examples 13-19 includes, wherein the instructions further cause the processing circuitry to perform operations comprising receiving, on the user interface, a selection to send the personalized promotion to the customer.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
retrieving historical transaction data relating to prior transactions at a retail location;
creating a customer profile for a customer of the retail location based on transactions associated with the customer from the historical transaction data;
generating, using a trained large language model, a personalized promotion redeemable at the retail location for the customer based on the customer profile;
generating, using the trained large language model, a justification for the personalized promotion based on the customer profile; and
outputting an indication of the personalized promotion on a user interface corresponding to the retail location.

2. The method of claim 1, further comprising stratifying a customer into a stratum based on values of customer transactions within the historical transaction data.

3. The method of claim 1, further comprising segmenting the customer into a segment based on types of customer transactions within the historical transaction data.

4. The method of claim 3, wherein the segment corresponds to a time of day of purchases, a day of week of purchases, or a frequency of transactions.

5. The method of claim 3, wherein the segment corresponds to a preferred product category of the customer extracted from the transactions associated with the customer.

6. The method of claim 1, wherein the personalized promotion is generated for the customer by the trained large language model from a set of preapproved potential personalized promotions.

7. The method of claim 6, wherein the set of preapproved potential personalized promotions are selected based on the customer profile.

8. The method of claim 1, further comprising, receiving, on the user interface, a selection to send the personalized promotion to the customer.

9. The method of claim 1, wherein outputting the indication includes outputting a promotion customized to the customer profile, receiving a selection to send the promotion customized to the customer profile, converting the promotion to two or more customer-specific promotions including the personalized promotion, and sending the two or more customer-specific promotions to respective customers having the customer profile including the customer.

10. The method of claim 1, wherein the personalized promotion is generated based on a command to increase check size for a future transaction of the customer or to increase a frequency of visits by the customer to the retail location.

11. The method of claim 1, wherein the historical transaction data is stored according to loyalty accounts of customers.

12. (canceled)

13. At least one non-transitory machine-readable medium including instructions, which when executed by processing circuitry, causes the processing circuitry to perform operations comprising:
retrieving historical transaction data relating to prior transactions at a retail location;
creating a customer profile for a customer of the retail location based on transactions associated with the customer from the historical transaction data;
generating, using a trained large language model, a personalized promotion redeemable at the retail location for the customer based on the customer profile;
generating, using the trained large language model, a justification for the personalized promotion based on the customer profile; and
outputting an indication of the personalized promotion on a user interface corresponding to the retail location.

14. The at least one non-transitory machine-readable medium of claim 13, wherein the instructions further cause the processing circuitry to perform operations comprising stratifying a customer into a stratum based on values of customer transactions within the historical transaction data.

15. The at least one non-transitory machine-readable medium of claim 13, wherein the instructions further cause the processing circuitry to perform operations comprising segmenting the customer into a segment based on types of customer transactions within the historical transaction data.

16. The at least one non-transitory machine-readable medium of claim 15, wherein the segment corresponds to a time of day of purchases, a day of week of purchases, or a frequency of transactions.

17. The at least one non-transitory machine-readable medium of claim 15, wherein the segment corresponds to a preferred product category of the customer extracted from the transactions associated with the customer.

18. The at least one non-transitory machine-readable medium of claim 13, wherein the personalized promotion is generated for the customer by the trained large language model from a set of preapproved potential personalized promotions.

19. The at least one non-transitory machine-readable medium of claim 18, wherein the set of preapproved potential personalized promotions are selected based on the customer profile.

20. The at least one non-transitory machine-readable medium of claim 13, wherein the instructions further cause the processing circuitry to perform operations comprising receiving, on the user interface, a selection to send the personalized promotion to the customer.
